(19) United States
(12) Patent Application Publication
(10) Pub. No.: US 2026/0324801 A1
(43) Pub. Date: Oct. 22, 2026

(54) METHOD OF FORMING SOLE STRUCTURE FOR ARTICLE OF FOOTWEAR

(71) Applicant: NIKE, Inc., Beaverton, OR (US)

(72) Inventors: Sami M. Fakhouri, Portland, OR (US); Alison C. Chew, Portland, OR (US); Timothy J. Slama, Portland, OR (US)

(73) Assignee: NIKE, Inc., Beaverton, OR (US)

(21) Appl. No.: 19/646,813

(22) Filed: Apr. 14, 2026

Related U.S. Application Data
(60) Provisional application No. 63/789,759, filed on Apr. 16, 2025.

(51) Int. Cl. A43B 13/18; A43B 13/12; A43B 13/22; B29D 35/12; B29K 105/04

(52) U.S. Cl. CPC A43B 13/184; A43B 13/122; A43B 13/22; B29D 35/122; B29K 2105/04

(57) ABSTRACT

A sole structure for an article of footwear includes a first support module including one or more support frames each having a support frame base, a support frame platform disposed at an opposite end from the support frame base, and one or more struts extending between the support frame base and the support frame platform. The sole structure further includes an outsole layer attached to the support frame.

### CROSS REFERENCE TO RELATED APPLICATIONS

This application claims priority under 35 U.S.C. § 119(e) to U.S. Provisional Application No. 63/789,759, filed on Apr. 16, 2025. The disclosure of this prior application is considered part of the disclosure of this application and is hereby incorporated by reference in its entirety.

### FIELD

The present disclosure relates generally to a method for forming a sole structure for an article of footwear.

### BACKGROUND

This section provides background information related to the present disclosure, which is not necessarily prior art.

Articles of footwear conventionally include an upper and a sole structure. The upper may be formed from any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. For example, a sole structure may include a midsole and an outsole. The midsole is generally disposed between the outsole and the upper and provides cushioning for the foot. The midsole may include various cushioning and support frames that compress resiliently under an applied load to cushion the foot by attenuating ground-reaction forces. Examples of known cushioning structures include resilient materials, such as foams, and fluid-filled structures, such as airbags or bladders. The outsole provides abrasion-resistance and traction with the ground surface and may be formed from rubber or other materials that impart durability and wear-resistance, as well as enhance traction with the ground surface.

While sole structures have proven acceptable for their intended purposes, a continuous need for improvement in the relevant art remains. A need also exists for an article of footwear having improved overall comfort and fit while providing such improved performance. Additionally, there is a growing demand for sole structures that offer enhanced energy return, which can improve athletic performance by reducing fatigue and increasing output. Furthermore, advancements in materials science present opportunities to develop lighter, more flexible sole structures without compromising durability or support. Cost efficiency is also a critical factor, as there is a need to produce high-performance sole structures at a lower cost.

### DRAWINGS

The drawings described herein are for illustrative purposes only of selected configurations and are not intended to limit the scope of the present disclosure.

FIG. 1 is a bottom perspective view of an example sole structure for an article of footwear according to the present disclosure;

FIG. 2 is a perspective view of an example of support unit according to the principles of the present disclosure;

FIG. 3 is a side elevation view of a support frame of the support unit of FIG. 2;

FIG. 4 is a side elevation view of the support unit of FIG. 2, including the support frame of FIG. 3 and an outsole layer;

FIG. 5 is an example of a support module according to the principles of the present disclosure;

FIG. 6 is a cross-sectional view of an example of a frame mold assembly according to the principles of the present disclosure, where the support frame mold assembly is in an open configuration;

FIG. 7 is a cross-sectional view of the support frame mold assembly of FIG. 6, where the support frame mold assembly is in a closed configuration;

FIG. 8 is a cross-sectional view of the support frame mold assembly of FIG. 6, where the support frame mold assembly is in a closed configuration and a frame material is provided to a mold cavity of the support frame mold assembly;

FIG. 9 is a cross-sectional view of the support frame mold assembly of FIG. 6, where the support frame material is cured to form a support frame;

FIG. 10 is a cross-sectional view of the support frame mold assembly of FIG. 6, where the support frame mold assembly is in the open configuration and the support frame is released;

FIG. 11 is a cross-sectional view of the released support frame of FIG. 10;

FIG. 12 is a cross-sectional view of an example of an outsole mold assembly according to the principles of the present disclosure, where the outsole mold assembly is in an open configuration;

FIG. 13 is a cross-sectional view of the outsole mold assembly of FIG. 12, where the outsole mold assembly is in an open configuration and the support frame is placed in a mold cavity of the outsole mold assembly;

FIG. 14 is a cross-sectional view of the outsole mold assembly of FIG. 12, where the outsole mold assembly is in a closed configuration and the support frame is placed in a mold cavity of the outsole mold assembly;

FIG. 15 is a cross-sectional view of the outsole mold assembly of FIG. 12, where the outsole mold assembly is in a closed configuration and an outsole material is provided to a mold cavity of the outsole mold assembly;

FIG. 16 is a cross-sectional view of the outsole mold assembly of FIG. 12, where the outsole material is cured to form a support unit including an outsole layer on the support frame;

FIG. 17 is a cross-sectional view of the outsole mold assembly of FIG. 12, where the outsole mold assembly is in the open configuration and the support unit is released;

FIG. 18 is a cross-sectional view of the released support unit of FIG. 10;

FIG. 19 is a cross-sectional view of another example of an outsole mold assembly according to the principles of the present disclosure, where the outsole mold assembly is in an open configuration;

FIG. 20 is a cross-sectional view of the outsole mold assembly of FIG. 19, where the outsole mold assembly is in a closed configuration;

FIG. 21 is a cross-sectional view of the outsole mold assembly of FIG. 19, where the outsole mold assembly is in a closed configuration and an outsole material is provided to a mold cavity of the outsole mold assembly;

FIG. 22 is a cross-sectional view of the outsole mold assembly of FIG. 19, where the outsole material is cured to form an outsole layer;

FIG. 23 is a cross-sectional view of the outsole mold assembly of FIG. 19, where the outsole mold assembly is in the open configuration and the outsole layer is released;

FIG. 24 is a cross-sectional view of an example support frame mold assembly according to the principles of the present disclosure, where the support frame mold assembly is in an open configuration and the outsole layer is placed in a mold cavity of the outsole mold assembly;

FIG. 25 is a cross-sectional view of the support frame mold assembly of FIG. 24, where the support frame mold assembly is in a closed configuration and the outsole layer is placed in the mold cavity of the support frame mold assembly;

FIG. 26 is a cross-sectional view of the outsole mold assembly of FIG. 24, where the support frame mold assembly is in a closed configuration and a support frame material is provided to a mold cavity of the support frame mold assembly;

FIG. 27 is a cross-sectional view of the outsole mold assembly of FIG. 24, where the support frame material is cured to form a support unit including the outsole layer on a support frame;

FIG. 28 is a cross-sectional view of the support frame mold assembly of FIG. 24, where the support frame mold assembly is in the open configuration and the support unit is released; and

FIG. 29 is a cross-sectional view of the released support unit of FIG. 28.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

Conventional cushioning elements for articles of footwear often rely on material properties of one or more compressible materials, such as fluids and polymers. For instance, known sole structures may include solid bodies of compressible foam materials to provide cushioning characteristics along the sole structure. Other examples may rely on compressible fluids, such as air or nitrogen, to provide cushioning characteristics. While suitable, the use of conventional compressible materials (e.g., foam, air) results in a direct relationship between displacement (e.g., compression) of the compressible material and load applied to the compressible material. In other words, increased displacement results in increased load. Furthermore, the stiffness of these materials also increases with displacement, causing the increases in load to become larger and larger. This relationship results in an underfoot feel in which increased loads associated with actions such as running or jumping (as opposed to lower loads associated with walking) may result in a stiffer underfoot feel as the cushioning material (e.g., air, foam) is compressed to a greater extent. Thus, replacing or supplementing conventional compressible materials with a mechanical structure according to the present disclosure may allow the underfoot feel to be modified to provide a constant response throughout the gait cycle. In some instances, it may be beneficial to include the mechanical cushioning structures along the ground-engaging surface of the sole structure. Accordingly, the present disclosure relates to systems and methods for forming a mechanical cushioning structure including an integrated outsole for improving traction between the mechanical cushioning structures and the ground surface.

An aspect of the disclosure provides a sole structure for an article of footwear. The sole structure includes a first support module including one or more support frames each having (i) a support frame base, (ii) a support frame platform disposed at an opposite end from the support frame base, and (iii) one or more struts extending between the support frame base and the support frame platform. The sole structure further includes an outsole layer attached to the support frame.

Aspects of the disclosure may include one or more of the following optional features. In some examples, the one or more support frames includes a plurality of the support frames each joined to an adjacent one of the support frames. In some examples, each of the one or more support frames is joined to at least one adjacent support frame along the support frame base. In some implementations, the support frame includes a first material and the outsole layer includes a second material different than the first material. In some examples, the second material has a lower durometer than the first material.

In some configurations, the outsole layer includes an outsole platform disposed on the support frame platform. In some examples, the outsole layer includes an outsole leg disposed at least one of the one or more struts. In some implementations, the outsole layer is co-molded with the support frame.

Another aspect of the disclosure provides a support module for a sole structure of an article of footwear. The support module includes one or more support frames each having (i) a support frame base, (ii) a support frame platform disposed at an opposite end from the support frame base, and (iii) one or more struts extending between the support frame base and the support frame platform, and an outsole layer attached to the support frame.

Aspects of the disclosure may include one or more of the following optional features. In some examples, the one or more support frames includes a plurality of the support frames each joined to an adjacent one of the support frames. In some implementations, each of the one or more support frames is joined to at least one adjacent support frame along the support frame base. In some configurations, the support frame includes a first material and the outsole layer includes a second material different than the first material. In some implementations, the second material has a lower durometer than the first material.

In some examples, the outsole layer includes an outsole platform disposed on the support frame platform. In some configurations, the outsole layer includes an outsole leg disposed at least one of the one or more struts.

Another aspect of the disclosure provides a method of forming a support unit for an article of footwear. The method includes molding a support frame having a support frame base, a support frame platform disposed at an opposite end from the support frame base, and at least one strut extending between the support frame base and the support frame platform, and molding an outsole layer onto to at least one of the support frame platform or one of the struts.

In some aspects of the disclosure, molding one of the support frame or the outsole layer includes providing a first molding material to a first mold cavity having the profile of the one of the support frame or the outsole layer.

In some examples, the method includes the step of transferring the one of the support frame or the outsole layer from the first mold cavity to a second mold cavity having the profile of the support frame and the outsole layer. In some examples, molding the other of the support frame or the outsole layer includes providing a second material to the second mold cavity, the second material filling a portion of the second mold cavity associated with the profile of the other of support frame or the outsole layer. In some examples, the support frame is formed using a supercritical foaming process.

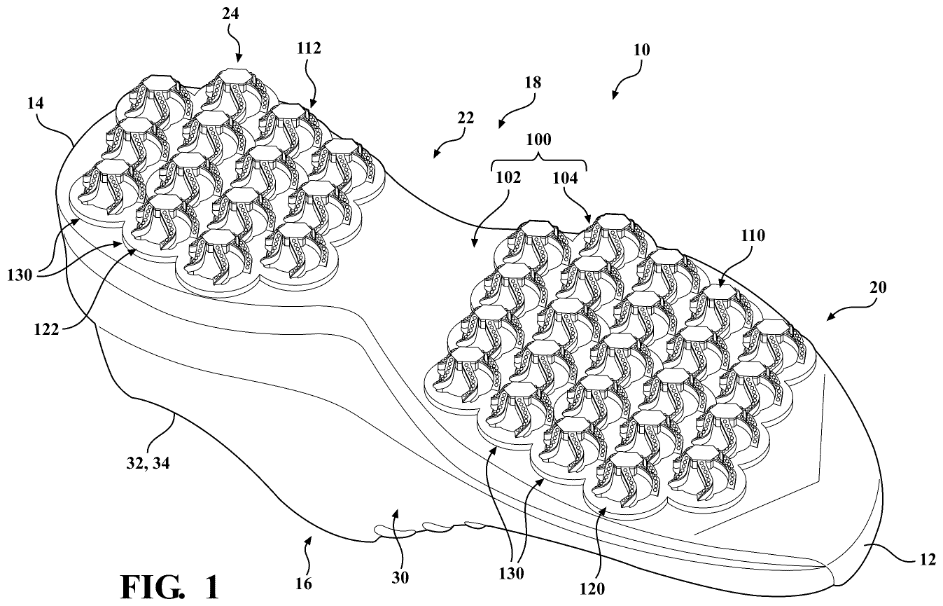

Referring to FIG. 1, an article of footwear 10 includes a sole structure 100 and an upper 30 attached to the sole structure 100. The footwear 10 may further include an anterior end 12 associated with a forward-most point of the footwear 10, and a posterior end 14 corresponding to a rearward-most point of the footwear 10. As shown in FIG. 1, a longitudinal axis A₁₀ of the footwear 10 extends along a length of the footwear 10 from the anterior end 12 to the posterior end 14 parallel to a ground surface, and generally divides the footwear 10 into a medial side 16 and a lateral side 18. Accordingly, the medial side 16 and the lateral side 18 respectively correspond with opposite sides of the footwear 10 and extend from the anterior end 12 to the posterior end 14. As used herein, a longitudinal direction refers to the direction extending from the anterior end 12 to the posterior end 14, while a lateral direction refers to the direction transverse to the longitudinal direction and extending from the medial side 16 to the lateral side 18.

The article of footwear 10 may be divided into one or more regions. The regions may include a forefoot region 20, a mid-foot region 22, and a heel region 24. The forefoot region 20 corresponds with phalanges and metatarsal bones of a foot. The mid-foot region 22 may correspond with an arch area of the foot, and the heel region 24 may correspond with rear portions of the foot, including a calcaneus bone.

The upper 30 forms an enclosure having plurality of components that cooperate to define an interior void 32 and an ankle opening 34, which cooperate to receive and secure a foot for support on the sole structure 100. The upper 30 may be formed from one or more materials that are stitched or adhesively bonded together to define the interior void 32. Suitable materials of the upper 30 may include, but are not limited to, textiles, foam, leather, and synthetic leather. The example upper 30 may be formed from a combination of one or more substantially inelastic or non-stretchable materials and one or more substantially elastic or stretchable materials disposed in different regions of the upper 30 to facilitate movement of the article of footwear 10 between the tightened state and the loosened state. The one or more elastic materials may include any combination of one or more elastic fabrics such as, without limitation, spandex, elastane, rubber or neoprene. The one or more inelastic materials may include any combination of one or more of thermoplastic polyurethanes, nylon, leather, vinyl, or another material/fabric that does not impart properties of elasticity.

The sole structure 100 includes midsole a 102 configured to provide cushioning and support and an outsole assembly 104 defining a ground-engaging surface (i.e., contacts the ground during a stance phase of a gait cycle) of the sole structure 100. Unlike conventional sole structures, which include monolithic midsoles and outsoles, the sole structure 100 of the present disclosure is configured as a composite structure including a plurality of components joined together. For example, the midsole 102 may include a cushioning layer attached to the upper 30 and extending continuously from the anterior end 12 to the posterior end 14. While the illustrated example provides the midsole 102 as an additional cushioning layer attached to the upper 30, the midsole 102 may be provided as a strobel that is integrated with the upper 30, whereby the outsole assembly 104 is attached directly to the strobel of the upper 30.

The outsole assembly 104 is attached to the midsole 102 to provide cushioning characteristics along with traction and abrasion resistance. The outsole assembly 104 includes one or more support modules 110, 112 providing traction and cushioning properties of the sole structure 100. In the illustrated example, the one or more support modules 110, 112 includes an anterior support module 110 disposed in the forefoot region 20 and a posterior support module 112 disposed in the heel region 24. The anterior support module 110 includes an anterior support assembly 120 having a first plurality of integrated support units 130. Similarly, the posterior support module 112 includes a posterior support assembly 122 including a second plurality of integrated support units 130. While the illustrated example shows a sole structure 100 including separate support modules 110, 112 in the forefoot region 20 and the heel region 24, it should be appreciated that other configurations of support modules may be incorporated into sole structures according to the principles of the present disclosure. For example, the sole structure 100 may include a single support module extending continuously from the anterior end 12 to the posterior end 14.

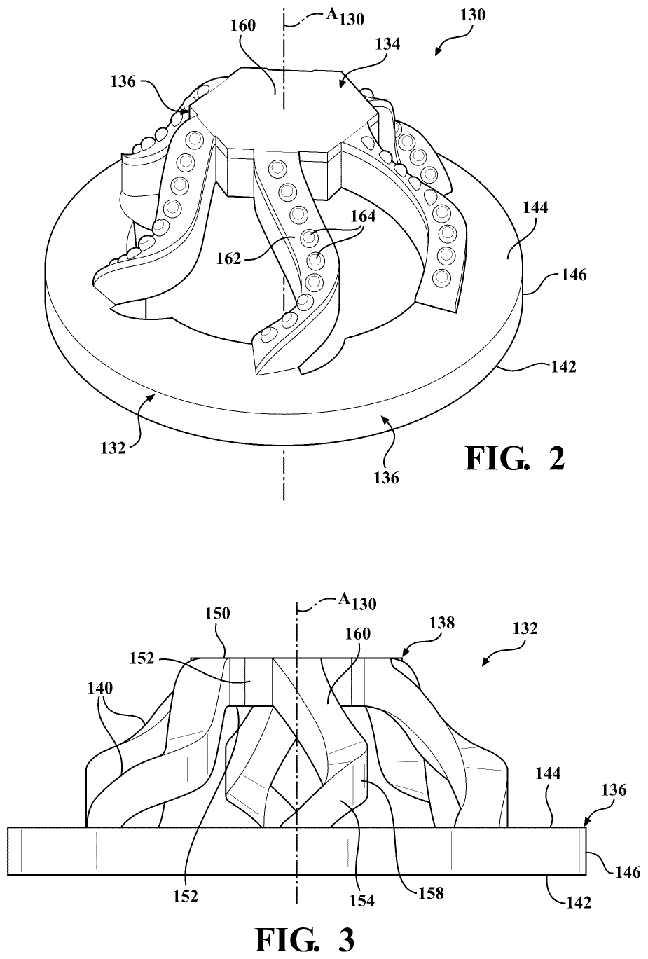

Referring to FIG. 2, an example of one of the support units 130 of the support modules 110, 112 is provided. As shown in FIG. 2, each of the support units 130 includes a support frame 132 forming the cushioning portion of the support unit 130 and an outsole layer 134 attached to the support frame 132 to provide traction and abrasion resistance to the support unit 130. While a single support unit 130 is illustrated in FIG. 2, any number of the support units 130 may be integrated to form each of the one or more support modules 110, 112 of the sole structure 100.

FIG. 3 provides a detailed view of the support frame 132 of the support unit 130. The support frame 132 includes a support frame base 136 at a first end and a support frame platform 138 disposed at an opposite end. The support frame base 136 is configured for attaching the support frame 132 and the support unit 130 to the midsole 102. Particularly, the support frame base 136 includes a top side 142 that attaches to the midsole 102 and a bottom side 144 disposed on an opposite side from the top side 142. The support frame base 136 further includes a peripheral side 146 that extends between the top side 142 and the bottom side 144 and defines an outer periphery of the support frame 132. While the illustrated example provides a cylindrical support frame base 136, the peripheral side 146 may have other shapes or may be merged with peripheral sides 146 of adjoining support frame bases 136 when the support units 130 are combined into the support modules 110, 112.

Referring still to FIG. 3, the support frame platform 138 is axially spaced from the support frame base 136 along the direction of the axis A₁₃₀. The support frame platform 138 includes a top side 148 facing the bottom side 144 of the support frame base 136, a bottom side 150 disposed on an opposite side from the top side 148, and a peripheral side 152 extending between the top side 148 and the bottom side 150. In the illustrated example, the peripheral side 152 defines a support frame platform 138 having a hexagonal shape. However, the support frame platform 138 may have other configurations, such as cylindrical or other polygonal geometries. When installed in the sole structure 100, the support frame platform 138 defines the ground-engaging structure of the support unit 130.

The support frame 132 further includes a plurality of struts 140 arranged about a central axis A₁₃₀ of the support unit 130 and each extending continuously between the support frame base 136 and the support frame platform 138. In this example, the struts 140 are arranged in an annular array around the central axis A₁₃₀. Each of the struts 140 extends continuously along a longitudinal axis A₁₄₀ from the support frame base 136 to the support frame platform 138. Here, one or more of the support frame struts 140 may converge with each other along a direction extending between the support frame base 136 and the support frame platform 138. For example, in the illustrated configuration, the support frames 132 include support frame struts 140 having longitudinal axes A₁₄₀ that converge with each other along a direction from the support frame base 136 to the support frame platform 138.

In some examples, all of the support frame struts 140 of the support frame 132 converge and intersect at respective vertices of a single support frame platform 138 to form a pyramidal structure. In other words, the support frame struts 140 are arranged as an array and each extend from a first end of the support frame 132 at the support frame base 136 to a second end of the support frame 132 at the support frame platform 138. For example, the illustrated support frames 132 include a hexagonal platform 138 having six sides and six corresponding support frame struts 140 each having an upper first strut portion 154 attached to the support frame base 136 and a upper lower second strut portion 156 attached to one of the sides of the support frame platform 138.

In the illustrated example, the support frames 132 are constructed with support frame struts 140 having intermediate elbows 158 or pre-bends formed between the upper strut portion 154 and the lower strut portion 156. The support frame struts 140 extend from the support frame base 136 at an oblique angle, but bend back towards the support frame platform 138 in an opposite direction, whereby the support frame platform 138 and the support frame base 136 have the same rotational orientation or clocking relative to the central axis A₁₃₀ of the support unit 130. Introducing the elbow 158 into the geometry of the support frame struts 140 has variable impacts on efficiency and unloading linearity. Particularly, increasing the degree of the pre-bend causes efficiency to increase while causing unloading linearity to decrease. While the illustrated example of the support frame 132 includes the elbow 158 with upper and lower strut portions 154, 156, the principles of the present disclosure relating to providing a support unit 130 having a support frame 132 and an outsole layer 134 can apply to a generic support frame strut formed with straight or arcuate support frame struts. In the illustrated example, the support frame struts 140 have a rectangular cross-sectional profile including an outer strut surface 157 that is flush with and extends from the bottom side 150 of the support frame platform 138. As discussed in greater detail below, the outer strut surface 157 cooperates with the bottom side 150 of the support frame platform 138 to define a portion of the ground-engaging structure of the support unit 130.

As provided above, each of the support frame struts 140 extends continuously between the support frame base 136 and the support frame platform 138. In other words, each support frame strut 140 only includes a pair of attachment points—one at each of the strut portions 154, 156—such that an intermediate portion is unconstrained and is free to flex or bend. Thus, each support frame strut 140 may be configured to act as a mechanical spring element, whereby a combination of the geometry and the material of the support frame strut 140 is selected to impart desired properties of cushioning and responsiveness. While the illustrated example contemplates forming the support frames using injection molding processes, the support frame 132 may also be formed using other suitable techniques, such as thermoforming (e.g. vacuum thermoforming), blow molding, extrusion, injection molding, vacuum molding, rotary molding, transfer molding, pressure forming, heat sealing, casting, low-pressure casting, spin casting, reaction injection molding, radio frequency (RF) welding, and the like. Optionally, the support frames 132 may be formed using a supercritical foaming process, whereby the support frame struts 140 or other portions of the support frames 132 include composite structures having an inner core formed of first material and an outer sheath formed of a second material. In such examples, at least a portion of the support frames 132 or the support frame struts 140 may be formed using a supercritical foaming process producing microcellular foam to form the inner core and the outer sheath.

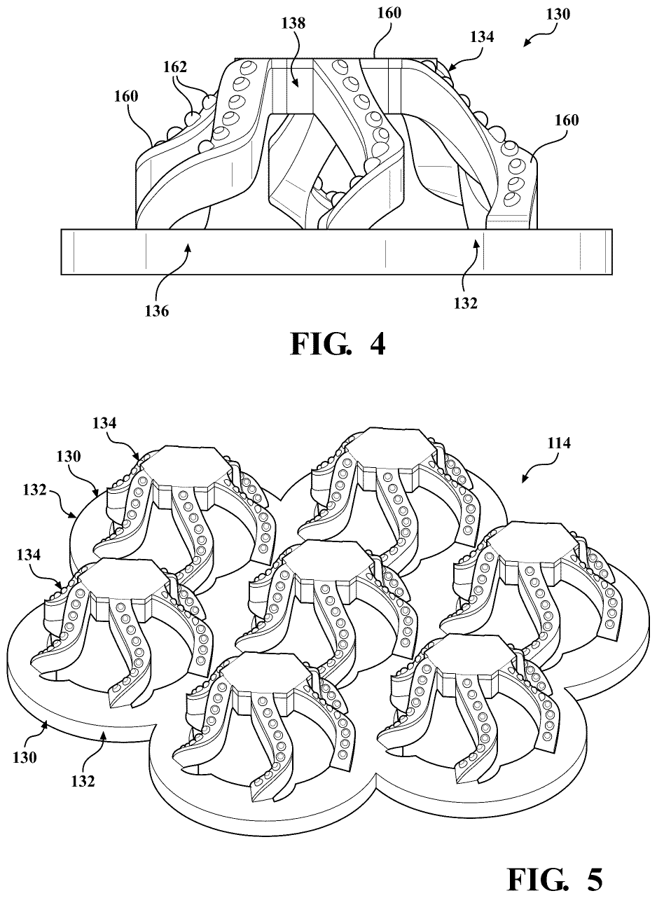

Referring to FIG. 4, the outsole layer 134 is attached to the support frame 132 and provides traction and abrasion resistance properties of the support unit 130. The outsole layer 134 includes an outsole platform 160 attached to the bottom side 150 of the support frame platform 138 and a plurality of outsole legs 162 each extending continuously along the outer strut surface 157 from the outsole platform 160 to the support frame base 136. Thus, the outsole layer 134 of the illustrated example defines a ground-contacting interface of the support unit 130. Optionally, the outsole layer 134 may include traction elements 164 formed along the outsole platform 160 and/or the outsole legs 162. As shown, the traction elements 164 are arranged in series along each of the outsole legs 162. Additionally or alternatively, the traction elements 164 may be formed on the outsole platform 160.

In use, the outsole layer 134 cooperates with the support frame 132 to define a ground-contacting interface of the support unit 130. The support unit 130 is configured such that the support frame platform 138 and the outsole platform 160 define an initial ground-contacting interface of the support unit 130 when the support unit 130 is in an uncompressed state (FIG. 4). When a compressive force is applied to the support unit 130 (e.g., during a stance phase of a gait cycle), the support frame platform 138 moves in a relative direction along the axis A₁₃₀ towards the support frame base 136 and an overall height of the support unit 132 is compressed. As the support unit 132 is compressed, the support frame struts 140 and the outsole legs 162 progressively engage the ground surface, with initial engagement beginning at the outsole platform 160 and progressing along the strut axis A₁₄₀ to the support frame base 136. Thus, under minimal loads, only a portion of the outsole leg 162 adjacent to the outsole platform 160 may engage with the ground surface. However, under increased loads, a greater portion of each outsole leg 162 engages the ground surface to provide increased engagement and traction between the sole structure 100 and the ground surface.

Referring now to FIG. 5, a generic example of a support module 114 is shown including a plurality of the support units 130 described previously. While the support module 114 is provided with seven of the support units 130 in a hexagonal arrangement, it should be appreciated that this illustration is provided only as an example of how the support units 130 can be arranged in any configuration along the sole structure 100, including as a single support module 114 or in combination with other modules arranged in different regions of the sole structure 100.

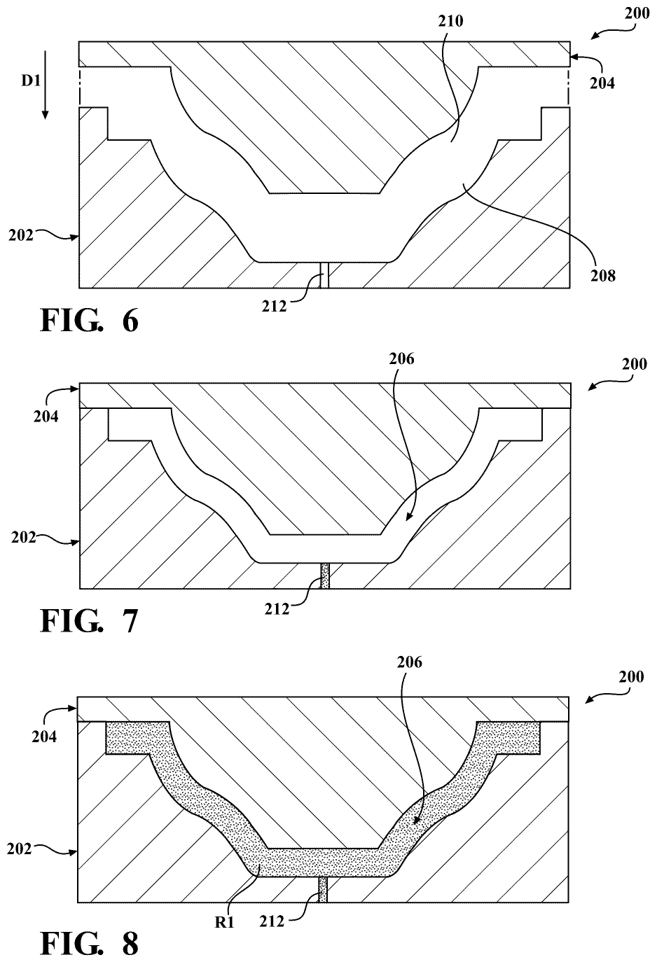

Referring to FIGS. 6-18, a system and method for forming a support unit 130 is provided. Particularly, FIGS. 6-11 show a first phase of the system and method for forming the support frame 132 of the support unit 130 and FIGS. 7-18 show a second phase of the system and method for forming the outsole layer 134 on the support frame 132. While FIGS. 6-18 show a system and method for forming a single support unit 130, it should be appreciated that a similar system and method would be used for forming any of the support modules 110, 112, 114, whereby the mold assemblies would be configured with cavities corresponding to the profiles of the support modules 110, 112, 114.

FIGS. 6 and 7 show a support frame mold assembly 200 including a first frame mold plate 202 and a second frame mold plate 204 that cooperate to form a support frame mold cavity 206 (FIG. 7) for forming the support frame 132. FIG. 6 shows the support frame mold assembly 200 in an open configuration. Here, the first frame mold plate 202 defines a first frame mold cavity portion 208 of the support frame mold cavity 206 and the second frame mold plate 204 defines a second frame mold cavity portion 210 of the support frame mold cavity 206. Generally, the first frame mold cavity portion 208 defines the top and upper portions of the support frame 132 and the second frame mold cavity portion 210 defines the bottom and lower portions of the support frame 132. However, the support frame mold assembly 200 is provided as a simplified example for forming the illustrated support unit 132, and other configurations of mold assemblies may be used. FIG. 7 shows the support frame mold assembly 200 in a closed configuration, wherein the first frame mold cavity portion 208 and the second frame mold cavity portion 210 cooperate to define the support frame mold cavity 206. The support frame mold assembly 200 further includes an inlet port 212 for providing a frame material R1 to the support frame mold cavity 206.

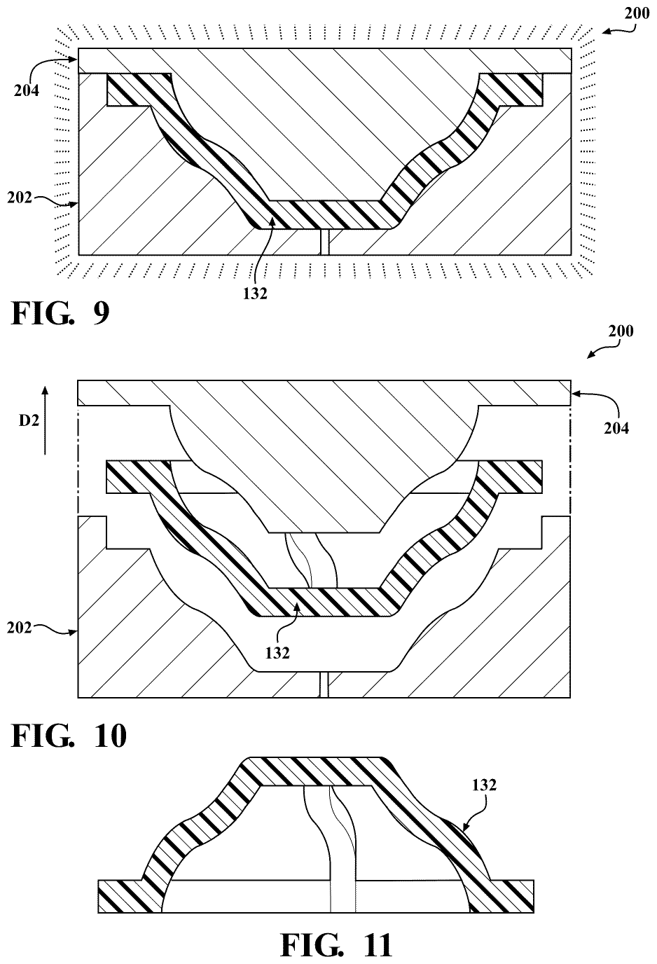

FIG. 8 shows a material provision step of the support frame molding process, wherein the support frame material R1 is provided to the support frame mold cavity 206. In the illustrated example, the support frame material R1 is provided as polymeric resin material R1 that is injected into the support frame mold cavity 206 via the inlet port 212. At FIG. 9, the support frame mold assembly 200 is energized to cure the support frame material R1 into a solidified state. The support frame material R1 may be cured using any suitable method for curing resins, such as heat and/or ultraviolet light. As discussed previously, the illustrated example shows a cured structure having a homogenous composition. However, the support frame mold assembly 200 may be configured for supercritical foaming, wherein one or more frame materials are provided to form a composite structure including an inner core having a first density and an outer shell having a second density that is greater than the first density of the inner core. At FIGS. 10 and 11, the support frame mold assembly 200 is moved to the open configuration and the finished support frame 132 is released from the support frame mold cavity 206.

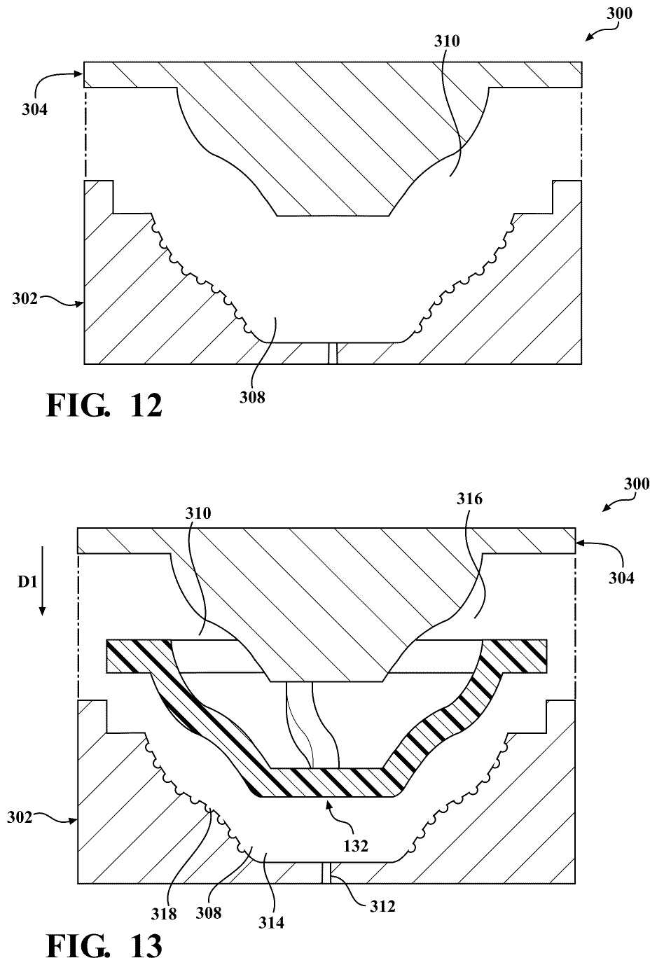

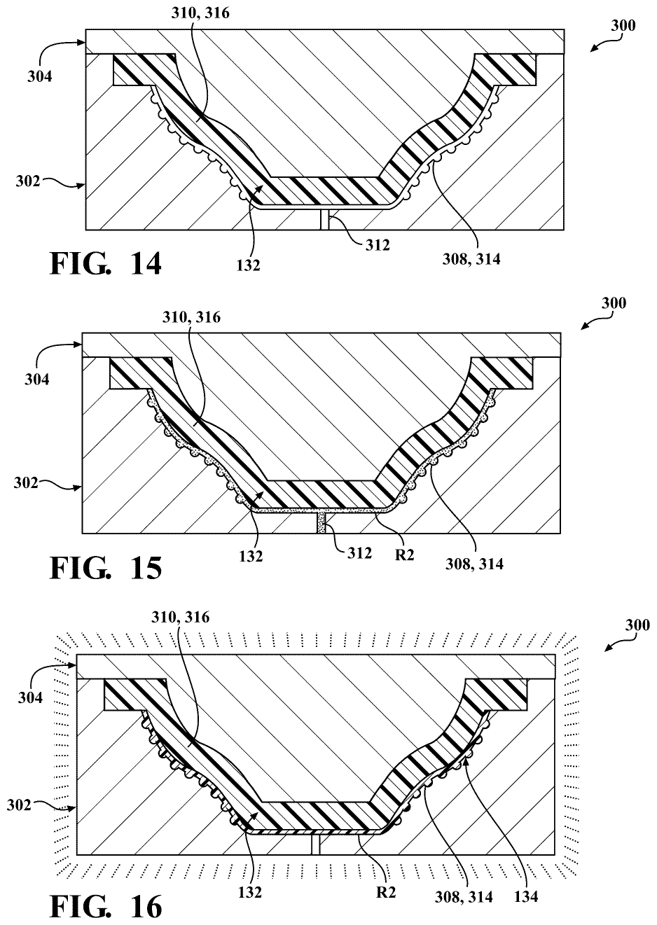

FIGS. 12-18 illustrate a second phase of the process for forming the support units 130 (or the support modules 110, 112, 114). FIGS. 12 and 13 show an outsole mold assembly 300 including a first outsole mold plate 302 and a second outsole mold plate 304 that cooperate to form an outsole mold cavity 306 (FIG. 13) for forming the outsole layer 134 of the support unit 130. FIG. 12 shows the outsole mold assembly 300 in an open configuration. Here, the first outsole mold plate 302 defines a first outsole mold cavity portion 308 of the outsole mold cavity 306 and the second outsole mold plate 304 defines a second outsole mold cavity portion 310 of the outsole mold cavity 306. Generally, the first outsole mold cavity portion 308 defines a profile of the outsole layer 134 and the second outsole mold cavity portion 310 receives the support frame 132. However, outsole mold assembly 300 is provided as a simplified example for forming the illustrated support unit 132, and other configurations of outsole molding assemblies may be used. The outsole mold assembly 300 further includes an inlet port 312 for providing an outsole material R2 to the outsole mold cavity 306. In FIG. 13, the support frame 132 is placed within the outsole mold cavity 306 and the outsole mold assembly 300 is subsequently moved to the closed configuration (FIG. 14).

FIG. 14 shows the outsole mold assembly 300 in a closed configuration, wherein the first outsole mold cavity portion 308 and the second outsole mold cavity portion 310 cooperate to define the outsole mold cavity 306. As shown, the support unit 132 is disposed within the outsole mold cavity 306 against the second outsole mold plate 304. In other words, the outsole mold cavity 306 defines a frame receptacle 316 generally associated with the first outsole mold cavity portion 308 and including portions of the outsole mold assembly 300 that contact the support frame 132. The outsole mold cavity 306 further includes an outsole molding portion 314 defined by portions of the second outsole mold cavity portion 310 where the outsole mold assembly 300 is spaced apart from the support frame 132. In the illustrated example, the outsole mold assembly 300 is spaced apart from the bottom side 150 of the support frame platform 138 and the outer strut surface 157 to define a void corresponding to the shapes of the outsole platform 160 and each of the outsole legs 162.

FIG. 15 shows a material provision step of the outsole molding process, wherein an outsole material R2 is provided to the outsole mold cavity 306. In the illustrated example, the outsole material R2 is provided as polymeric resin material R2 that is injected into the outsole molding portion 314 of the outsole mold cavity 306 via the inlet port 312. At FIG. 16, the outsole mold assembly 300 is energized to cure the outsole material R2 into a solidified state, thereby forming the outsole layer 134 on the support frame 132. Thus, the outsole layer 134 and the support frame 132 are co-molded during the second phase to form the support frame 132.

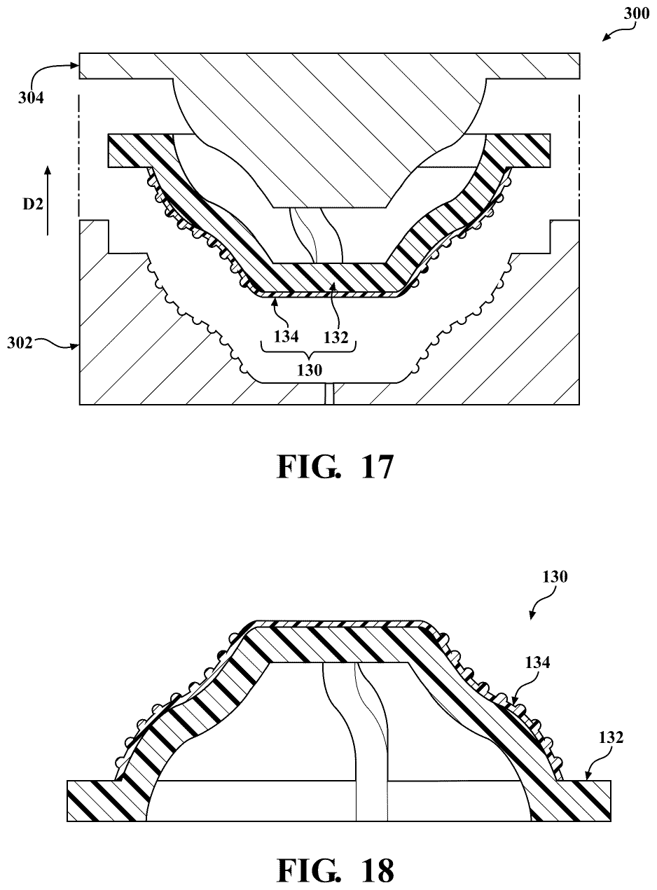

Once cured, the outsole layer 134 is attached or bonded to the bottom side 150 and the outer strut surfaces 157 via a chemical bond between the support frame material R1 and the outsole material R2. Further, the cured outsole material R2 has a lower durometer than the support frame material R1 to provide improved traction properties to the support unit 130. Optionally, one or more bonding agents and or mechanical coupling elements may be provided between the support frame material R1 and the outsole material R2 to attach the outsole layer 134 to the support frame 132. For example, the support frame 132 may include on or more recesses formed in the bottom side 150 and/or outer strut surfaces 157. During molding of the outsole layer 134, the outsole material R2 will flow into these recesses to increase mechanical engagement between the support frame 132 and the outsole layer 134. At FIGS. 17 and 18, the outsole mold assembly 300 is moved to the open configuration and the finished support unit 130 is released from the outsole mold cavity 306.

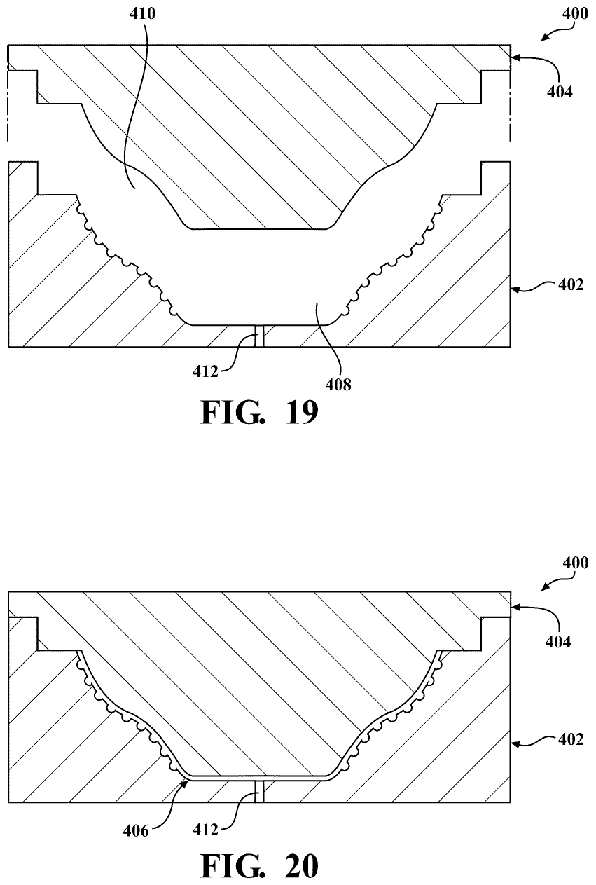

Referring to FIGS. 19-29, a system and method for forming a support unit 130 is provided. Particularly, FIGS. 19-23 show a first phase of the system and method for forming the outsole layer 134 of the support unit 130 and FIGS. 24-29 show a second phase of the system and method for forming the support frame 132 on the outsole layer 134. While FIGS. 19-29 show a system and method for forming a single support unit 130, it should be appreciated that a similar system and method would be used for forming any of the support modules 110, 112, 114, whereby the mold assemblies would be configured with cavities corresponding to the profiles of the support modules 110, 112, 114.

FIGS. 19 and 20 show an outsole mold assembly 400 including a first outsole mold plate 402 and a second outsole mold plate 404 that cooperate to form an outsole mold cavity 406 (FIG. 20) for forming the outsole layer 134. FIG. 19 shows the outsole mold assembly 400 in an open configuration. Here, the first outsole mold plate 402 defines a first outsole cavity portion 408 of the outsole mold cavity 406 and the second outsole mold plate 404 defines a second outsole cavity portion 410 of the outsole mold cavity 406. Generally, the first outsole cavity portion 408 defines the bottom and lower portions of the outsole layer 134 and the second outsole cavity portion 410 defines the top and upper portions of the outsole layer 134. FIG. 20 shows the outsole mold assembly 400 in a closed configuration, wherein the first outsole cavity portion 408 and the second outsole cavity portion 410 cooperate to define the outsole mold cavity 406. The outsole mold assembly 400 further includes an inlet port 412 for providing the outsole material R2 to the outsole mold cavity 406. The outsole mold assembly 400 is provided as a simplified example for forming the illustrated outsole layer 134 and other configurations of mold assemblies forming the outsole mold cavity 406 may be used.

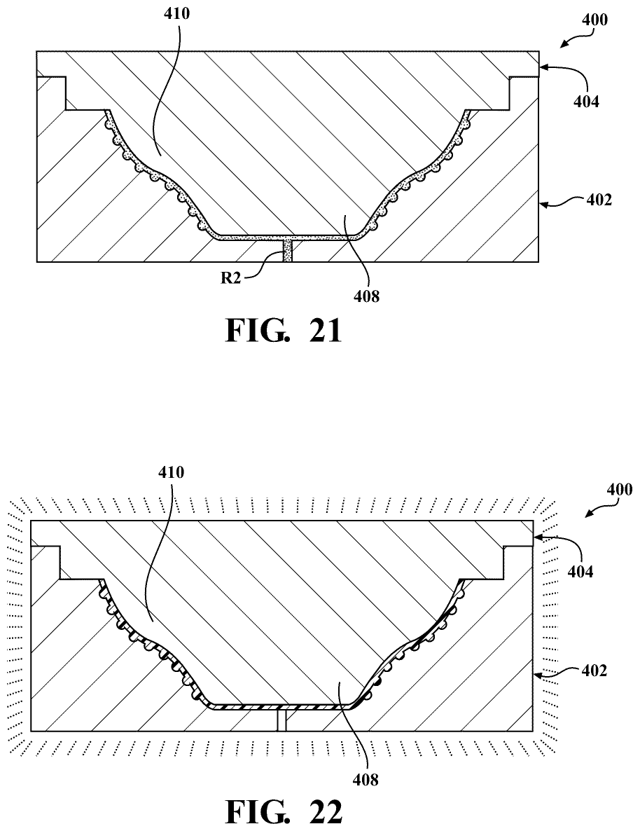

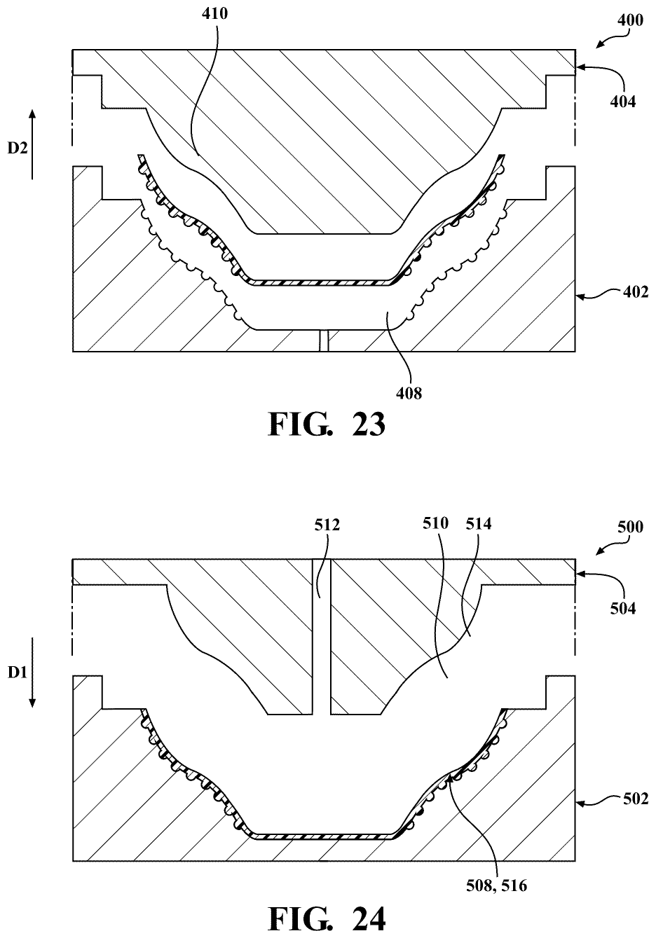

FIG. 21 shows a material provision step of the outsole molding process, wherein the outsole material R2 is provided to the outsole mold cavity 406. In the illustrated example, the outsole material R2 is provided as polymeric resin material R2 that is injected into the outsole mold cavity 406 via the inlet port 412. At FIG. 22, the outsole mold assembly 400 is energized to cure the outsole material R2 into a solidified state. The outsole material R2 may be cured using any suitable method for curing resins, such as heat and/or ultraviolet light. At FIG. 23, the outsole mold assembly 400 is moved to the open configuration and the cured outsole layer 134 is removed from the outsole mold cavity 406.

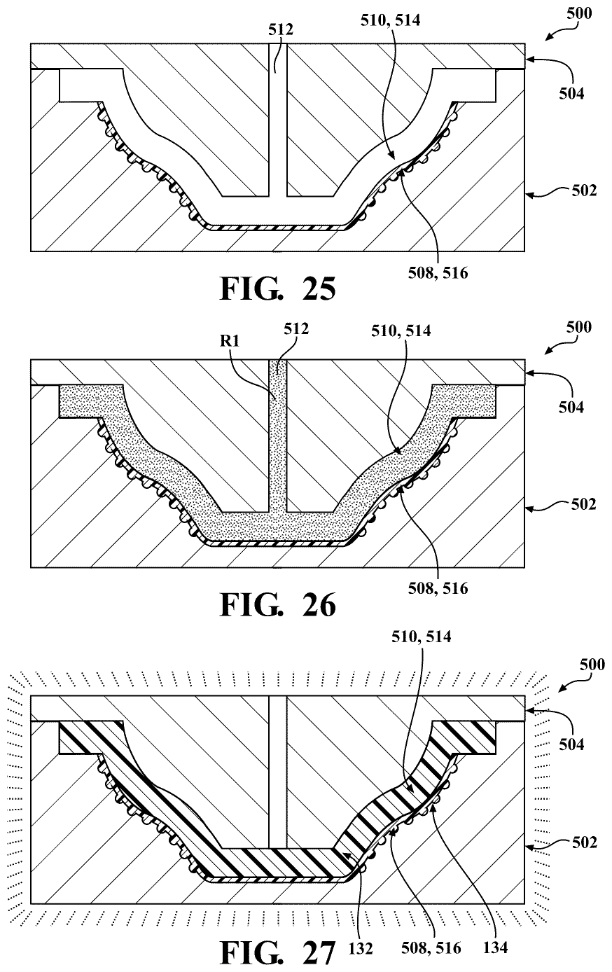

FIGS. 24-28 illustrate a second phase of the process for forming the support units 130 (or the support modules 110, 112, 114). FIGS. 24 and 25 show a support frame mold assembly 500 including a first support frame mold plate 502 and a second support frame mold plate 504 that cooperate to form a support frame mold cavity 506 (FIG. 25) for forming the support frame 132 of the support unit 130. FIG. 24 shows the support frame mold assembly 500 in an open configuration. Here, the first support frame mold plate 502 defines a first support frame mold cavity portion 508 of the support frame mold cavity 506 and the second support frame mold plate 504 defines a second support frame mold cavity portion 510 of the support frame mold cavity 506. Generally, the first support frame mold cavity portion 508 defines a profile of the support frame 132 and the second support frame mold cavity portion 510 receives the outsole layer 134. The support frame mold assembly 500 is provided as a simplified example for forming the illustrated support unit 130, and other configurations of support frame molding assemblies may be used. The support frame mold assembly 500 further includes an inlet port 512 for providing a support frame material R1 to the support frame mold cavity 506. In FIG. 24, the outsole layer 134 is placed within the support frame mold cavity 506 and the support frame mold assembly 500 is subsequently moved to the closed configuration (FIG. 25).

FIG. 25 shows the support frame mold assembly 500 in a closed configuration, wherein the first support frame mold cavity portion 508 and the second support frame mold cavity portion 510 cooperate to define the support frame mold cavity 506. As shown, the outsole layer 134 is disposed within the support frame mold cavity 506 against the first support frame mold plate 502. In other words, the support frame mold cavity 506 defines an outsole layer receptacle 516 generally associated with the first support frame mold cavity portion 508 and including portions of the support frame mold assembly 500 that contact the outsole layer 134. The support frame mold cavity 506 further includes a support frame molding portion 514 defined by portions of the second support frame mold cavity portion 510 where the support frame mold assembly 500 is spaced apart from the outsole layer 134 to define a void corresponding to the shapes of the support frame platform 138 and each of the support frame struts 140.

FIG. 26 shows a material provision step of the support frame molding process, wherein a support frame material R1 is provided to the support frame mold cavity 506. In the illustrated example, the support frame material R1 is provided as polymeric resin material R1 that is injected into the support frame molding portion 514 of the support frame mold cavity 506 via the inlet port 512. At FIG. 27, the support frame mold assembly 500 is energized to cure the support frame material R1 into a solidified state, thereby forming the support frame 132 on the outsole layer 134. As discussed previously, the illustrated example shows a cured structure having a homogenous composition. However, the support frame mold assembly 500 may be configured for supercritical foaming, wherein one or more frame materials are provided to form a composite structure including an inner core having a first density and an outer shell having a second density that is greater than the first density of the inner core.

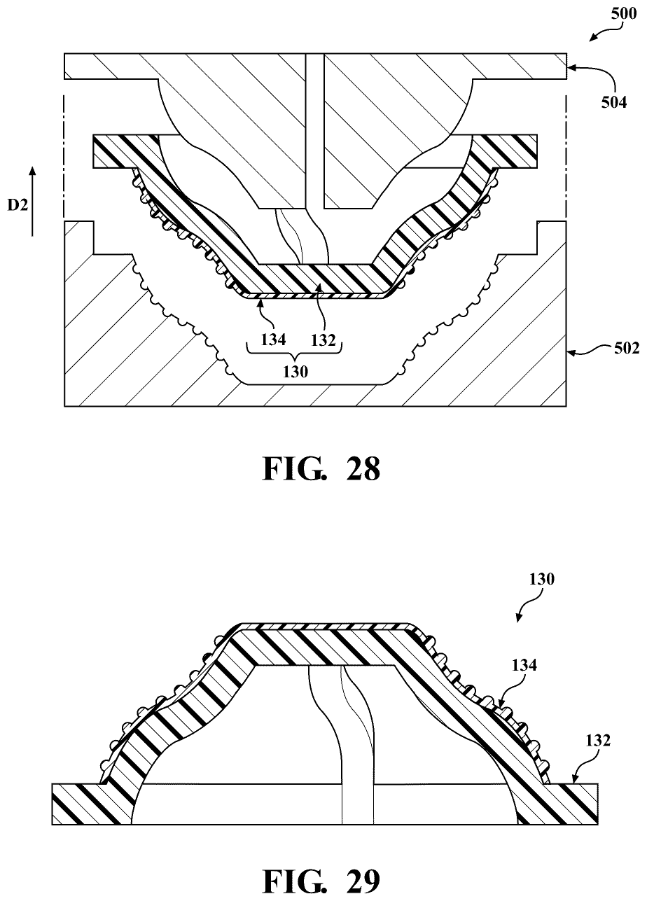

Once cured, the outsole layer 134 is attached or bonded to the bottom side 150 and the outer strut surfaces 157 via a chemical bond between the support frame material R1 and the outsole material R2. Further, the cured outsole material R2 has a lower durometer than the support frame material R1 to provide improved traction properties to the support unit 130. Optionally, one or more bonding agents and or mechanical coupling elements may be provided between the support frame material R1 and the outsole material R2 to attach the outsole layer 134 to the support frame 132. For example, the support frame 132 may include on or more recesses formed in the bottom side 150 and/or outer strut surfaces 157. During molding of the outsole layer 134, the outsole material R2 will flow into these recesses to increase mechanical engagement between the support frame 132 and the outsole layer 134. Thus, the outsole layer 134 and the support frame 132 are co-molded during the second phase to form the support unit 130. At FIG. 28, the support frame mold assembly 500 is moved to the open configuration and the finished support unit 130 is released from the support frame mold cavity 506.

As set forth above, FIGS. 6-18 provide a first system 200, 300 and method for forming the support unit 130, wherein the support frame 132 is formed first and then the outsole layer 134 if formed on the support frame 132. Conversely, FIGS. 19-29 provide a second system 400, 500 and method for forming the support unit 130, wherein the outsole layer 134 is formed used and then the support frame 132 is formed on the outsole layer 134. The system and method used to form the support unit 130 is selected based on the melting point for the materials R1, R2 used for the support frame 132 and the outsole layer 134. When the outsole material R2 has a lower melting point than the support frame material R1, the outsole layer 134 will be formed after the support frame 132 using the first system 200, 300 and method. Thus, the support frame material R1, having a higher melting temperature, will remain solid as the outsole material R2 is provided to the outsole mold cavity 306. Conversely, when the outsole material R2 has a greater melting point than the support frame material R1, the support frame unit 130 will be formed using the system 400, 500 and method of FIGS. 19-29.

The support frames 132, the support frame struts 140 (e.g., the first strut, the second strut, etc.), and/or the outsole layers 134 may be made using polymeric materials (e.g., a polymeric first sheath material, a polymeric first core material, a polymeric second sheath material, a polymeric second core material, a polymeric filler material, etc.). Accordingly, the polymeric materials described herein are understood to comprise, consist essentially of, or consist of one or more polymers. All the one or more polymers present in a polymeric material constitute the polymeric component of the polymeric material. Similarly, when a polymeric material comprises one or more non-polymer additives, all of the non-polymeric additives present in the polymeric material constitute the non-polymeric component of the polymeric material. The one or more polymers of a polymeric material may comprise, consist essentially of, or consist of thermoplastics. A thermoplastic is a polymer that is a solid when cooled, and which can be repeatedly softened and melted on heating. The one or more polymers of a polymeric material may comprise, consist essentially of, or consist of elastomers. An elastomer may be defined as a polymer having an elongation at break greater than 100 percent, or greater than 200 percent, or greater than 400 percent, as determined using ASTM D-412-98 at 25 degrees Celsius. An elastomeric material may be defined as a composition having an elongation at break greater than 100 percent, or greater than 200 percent, or greater than 400 percent, as determined using ASTM D-412-98 at 25 degrees Celsius.

The one or more polymers of a polymeric material may include one or more of a variety of polymers, including homopolymers and copolymers and combinations of homopolymers and copolymers. The one or more polymers may comprise, consist essentially of, or consist of a polymer chosen from a polyurethane, a polyurea, a polyester, a polyether, a polyamide, a polyimide, a polyolefin, a polystyrene, a polysiloxane, a polycarbonate, a polyacetate, and any combination thereof, including homopolymers and copolymers thereof. The one or more polymers may comprise, consist essentially of, or consist of a polymer chosen from a polyurethane, a polyester, a polyamide, a polystyrene, a polyolefin, and any combination thereof, including homopolymers and copolymers thereof. The one or more polymers may comprise, consist essentially of, or consist of polyurethanes. Examples of polyurethanes include thermoplastic polyurethanes (TPUs), such as polyester-polyurethane copolymers and polyether-polyurethane copolymers, including thermoplastic elastomeric polyurethanes. The one or more polymers may comprise, consist essentially of, or consist of polyesters. Examples polyesters include polyester homopolymers such as polyethylene terephthalate (PET), and polyester copolymers such as polyetheresters, including thermoplastic polyester copolymers. The one or more polymers may comprise, consist essentially of, or consist of polyamides. Examples of polyamide homopolymers include thermoplastic polyamide homopolymers such as Nylon-6, Nylon-6,6, and Nylon-11. Examples of polyamide copolymers include thermoplastic polyamide copolymers such as thermoplastic elastomeric polyamide block copolymers, for example polyether block amide (PEBA) thermoplastic elastomers. The one or more polymers may comprise, consist essentially of, or consist of polystyrenes. Examples of polystyrenes include thermoplastic polystyrene homopolymers such as thermoplastic polystyrene homopolymer elastomers. Examples of polystyrenes also include thermoplastic polystyrene copolymers such as thermoplastic polystyrene copolymer elastomers, for example, a styrene-butadiene-styrene (SBS) copolymer or a styrene-ethylene-butadiene-styrene (SEBS) copolymer. The one or more polymers may comprise, consist essentially of, or consist of polyolefins. Examples of polyolefins include thermoplastic polyolefin elastomers, including thermoplastic polyolefin homopolymer elastomers and thermoplastic polyolefin copolymer elastomers. Examples of polyolefin homopolymers include polyethylene and polypropylene. Examples of polyolefin copolymers include polyethylene-polypropylene copolymers, as well as ethylene-vinyl acetate copolymers (EVA) and ethylene-vinyl alcohol (EVOH) copolymers.

The polymeric material may comprise from about 5 weight percent to about 100 weight percent of the polymeric component based on a total weight of the polymeric material. The polymeric component can comprise from about 15 weight percent to about 100 weight percent, from about 30 weight percent to about 100 weight percent, from about 50 weight percent to about 100 weight percent, or from about 70 weight percent to about 100 weight percent of the polymeric material. When the polymeric material comprises a non-polymeric component, the non-polymeric component may comprise from about 1 weight percent to about 20 weight percent, or from about 1 weight percent to about 10 weight percent, or from about 1 weight percent to about 5 weight percent based on a total weight of the polymeric material. As used herein, the terms “consist essentially of”, “consists essentially of” and “consisting essentially of” refer to compositions which consist of less than 1 weight percent of materials other than those recited, based on a total weight of the composition. For example, “a polymeric material consisting essentially of thermoplastics” is understood to be a polymeric material which included less than 1 weight percent of non-thermoplastic polymers and non-polymeric materials; while “a polymeric material comprising a polymeric component consisting essentially of thermoplastics” is understood to include a polymeric component in which less than 1 weight percent of the polymers present are non-thermoplastic polymers, but this polymeric material may include more than 1 weight percent of non-polymeric materials.

In some aspects, the polymeric material may be a material which polymerizes or crosslinks or both polymerizes and crosslinks during the process of forming the support or during the process of forming the sole structure. The polymerization or crosslinking may be initiated by including a chemical polymerization or crosslinking initiator in the polymeric material (e.g., a chemical which initiates polymerization or crosslinking reactions within the polymeric material when it is exposed to thermal energy, UV light, or another form of actinic radiation), or the polymerization or crosslinking may be initiated by mixing together two compositions which react to produce polymerization or crosslinking reactions, or by exposing a polymeric material to a form of actinic radiation in sufficient quantity to polymerize pre-polymers or oligomers present in the exposed material, or to crosslink polymers present in the exposed polymeric material. In aspects where the material polymerizes, the polymeric material may initially comprise one or more pre-polymers or oligomers which react and polymerize during the manufacturing process, resulting in a support or sole structure comprising the reacted polymeric material. In aspects where the material crosslinks, the polymeric material may initially comprise one or more crosslinkable polymers which react with crosslinking agents or crosslinking energy and become crosslinked polymers during the manufacturing process, resulting in a support or sole structure comprising a crosslinked polymeric material. In some aspect, the resulting reacted polymeric material is a thermoset material. Similarly, in some aspects, the initial polymeric material may be a thermosetting thermoplastic material (e.g., a polymeric material comprising one or more thermoplastics and a crosslinking agent before it is thermally processed), and the resulting crosslinked polymeric material is a thermoset material (e.g., after the crosslinking agent reacts with the thermoplastics and crosslinks them, and the resulting thermoset material is solidified). One example of this is a thermosettable molten thermoplastic material comprising a thermally-activated crosslinking agent and a foaming agent, where the thermally-activated crosslinking agent is activated during a foaming process, resulting in a thermoset foam material.

Optionally, the polymeric material may comprise one or more additives. Examples of additives include fillers, polymerization initiators, crosslinking agents, UV light absorbers, anti-oxidants, processing aids such as lubricants and plasticizers, and colorants, such as pigments and dyes. Fillers may include non-polymeric fillers such as silica, clay, and titanium dioxide. Fillers may include polymeric fillers such as polymeric fibers and finely-ground polymeric powders, including ground thermoset rubber. Colorants such as naturally-occurring and synthetic pigments and dyes may be used. The polymeric material may comprise one or more additives at a concentration of from about 0.1 weight percent to about 20 weight percent, or from about 0.2 weight percent to about 10 weight percent, or from about 0.5 weight percent to about 5 weight percent, based on a total weight of the polymeric material.

The polymeric material may include one or more foaming agents. As understood in the art, foaming agents are substances that react, decompose or vaporize to produce quantities of gases or vapors. A chemical foaming agent is a compound which, when reacted with a second chemical or on decomposition, release a gas. Examples of chemical foaming agents include sodium bicarbonate, ammonium carbonate, ammonium bicarbonate, calcium azide, azodicarbonamide, hydrazocarbonamide, benzenesulfonyl hydrazide, dinitrosopentamethylene tetramine, toluenesulfonyl hydrazide, p,p′-oxybis(benzenesulfonylhydrazide), azobisisobutyronitrile, barium azodicarboxylate, and any combination thereof. A physical blowing agent is a compound which phase transitions from a solid, liquid or supercritical fluid to a gas when the temperature, pressure, or temperature and pressure are changed. Physical blowing agents include low-boiling-point hydrocarbons, including hydrocarbons such as isobutene and pentane, and partially halogenated hydrocarbons such as partially halogenated fluorochlorohydrocarbons, inert gasses, and supercritical fluids. In some aspects, the foaming agent is a supercritical fluid, such as supercritical carbon dioxide (CO2) or supercritical nitrogen (N2). The one or more foaming agents may include a chemical foaming agent and a physical foaming agent.

When a foaming agent is used, prior to the foaming step, the foaming agent may be present in the polymeric material in an amount effective to foam the polymeric material into a multicellular foam during the manufacturing process. The amount of foaming agent may be measured as the concentration of foaming agent by weight in the polymeric material prior to the foaming step. An amount of blowing agent is considered effective when the foaming process results in at least a 10 percent increase in the volume of the polymeric material, or at least a 20 percent increase in the volume of the polymeric material, or in at least a 30 percent increase in the volume of the polymeric material. The polymeric material may comprise from about 1 percent to about 30 percent by weight, or from about 1 percent to about 20 percent by weight, or from about 1 percent to about 10 percent by weight of the foaming agent based on a total weight of the polymeric material. The polymeric material may comprise a concentration of the foaming agent sufficient to expand the polymeric material by at least 100 percent by volume, or by 100 percent to 900 percent by volume, or by 200 percent to 500 percent by volume, or by 300 percent to 400 percent by volume, based on an initial volume of the polymeric material prior to foaming.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A sole structure for an article of footwear, the sole structure comprising:
a first support module including (a) one or more support frames each having (i) a support frame base, (ii) a support frame platform disposed at an opposite end from the support frame base, and (iii) one or more struts extending between the support frame base and the support frame platform, and (b) an outsole layer attached to the support frame.

2. The sole structure of claim 1, wherein the one or more support frames includes a plurality of the support frames each joined to an adjacent one of the support frames.

3. The sole structure of claim 2, wherein each of the one or more support frames is joined to at least one adjacent support frame along the support frame base.

4. The sole structure of claim 1, wherein the support frame includes a first material and the outsole layer includes a second material different than the first material.

5. The sole structure of claim 4, wherein the second material has a lower durometer than the first material.

6. The sole structure of claim 1, wherein the outsole layer includes an outsole platform disposed on the support frame platform.

7. The sole structure of claim 1, wherein the outsole layer includes an outsole leg disposed at least one of the one or more struts.

8. The sole structure of claim 1, wherein the outsole layer is co-molded with the support frame.

9. A support module for a sole structure of an article of footwear, the support module comprising:
one or more support frames each having (i) a support frame base, (ii) a support frame platform disposed at an opposite end from the support frame base, and (iii) one or more struts extending between the support frame base and the support frame platform; and
an outsole layer attached to the support frame.

10. The support module of claim 9, wherein the one or more support frames includes a plurality of the support frames each joined to an adjacent one of the support frames.

11. The support module of claim 10, wherein each of the one or more support frames is joined to at least one adjacent support frame along the support frame base.

12. The support module of claim 9, wherein the support frame includes a first material and the outsole layer includes a second material different than the first material.

13. The support module of claim 12, wherein the second material has a lower durometer than the first material.

14. The support module of claim 9, wherein the outsole layer includes an outsole platform disposed on the support frame platform.

15. The support module of claim 9, wherein the outsole layer includes an outsole leg disposed at least one of the one or more struts.

16. A method of forming a support unit for an article of footwear, the method comprising:
molding a support frame having a support frame base, a support frame platform disposed at an opposite end from the support frame base, and at least one strut extending between the support frame base and the support frame platform; and
molding an outsole layer onto to at least one of the support frame platform or one of the struts.

17. The method of claim 16, wherein molding one of the support frame or the outsole layer includes providing a first molding material to a first mold cavity having the profile of the one of the support frame or the outsole layer.

18. The method of claim 17, further comprising the step of transferring the one of the support frame or the outsole layer from the first mold cavity to a second mold cavity having the profile of the support frame and the outsole layer.

19. The method of claim 18, wherein molding the other of the support frame or the outsole layer includes providing a second material to the second mold cavity, the second material filling a portion of the second mold cavity associated with the profile of the other of support frame or the outsole layer.

20. The method of claim 19, wherein the support frame is formed using a supercritical foaming process.
